(19) United States
(12) Patent Application Publication
(10) Pub. No.: US 2012/0186796 A1
(43) Pub. Date: Jul. 26, 2012

(54) HEAT EXCHANGER DEVICE AND USE THEREOF

(76) Inventors: Thomas Uhrig, Geisingen (DE); Anton Gerstmaier, Geisingen/Gutmadingen (DE); Gerhard Keller, Geisingen/Gutmadingen (DE)

(21) Appl. No.: 13/388,052

(22) PCT Filed: Jul. 2, 2010
(86) PCT No.: PCT/EP10/04017

§ 371 Date: Apr. 10, 2012

(30) Foreign Application Priority Data
Jul. 30, 2009 (DE) 10-2009-035-271.6

(51) Int. Cl. F28F 9/04; B23P 15/26

(52) U.S. Cl. 165/178; 29/890.03

(57) ABSTRACT

The invention relates to a heat exchanger device to be introduced, along a longitudinal direction L, into a sewage pipeline extending along the longitudinal direction L, with a heat exchanger wall, comprising:—a first wall portion designed to make contact with sewage,—a second wall portion, spaced from the first wall portion, which is designed to make contact with the sewage pipeline, wherein the first wall portion and the second wall portion are arranged in a manner spaced from each other at least in some part(s) such that a heat exchanger chamber is formed between the first wall portion and the second wall portion, and—a third wall portion connecting the first wall portion and the second wall portion, the third wall portion at least in some part(s) forming a first supply line that can be flown through by a heat exchange medium, wherein the heat exchanger chamber is hydraulically connected to the first supply line via a first connection region,—a fourth wall portion connecting the first wall portion and the second wall portion, the fourth wall portion at least in some part(s) forming a second supply line that can be flown through by a heat exchange medium, wherein the heat exchanger chamber is hydraulically connected to the second supply line via a second connection region, and to a use thereof.

The invention relates to a heat exchanger device and a use of a heat exchanger device for forming a heat exchanger assembly.

Energy recovery from sewage by heat exchanger devices subsequently installed in a sewage pipeline has been known from the prior art, wherein the known heat exchanger devices are assembled from a plurality of elements, which requires greater assembling effort for manufacturing the heat exchanger device. Moreover, there exists a plurality of locations that are prone to corrosion, or a plurality of locations where matter from the sewage can deposit on the heat exchanger device.

An object of the present invention is to provide a heat exchanger device, which is easy to produce and requires less maintenance. This object is achieved by the subject matters of the independent claims. Preferred embodiments are subject of the dependent claims.

### Heat Exchanger Device

An aspect of the present invention relates to a heat exchanger device to be introduced, along a longitudinal direction L, into a sewage pipeline extending along the longitudinal direction L, with a heat exchanger wall, comprising:
a first wall portion designed to make contact with sewage,
a second wall portion, spaced from the first wall portion, which is designed to make contact with the sewage pipeline,
wherein the first wall portion and the second wall portion are arranged in a manner spaced from each other at least in some part(s) such that a heat exchanger chamber is formed between the first wall portion and the second wall portion, and
a third wall portion connecting the first wall portion and the second wall portion, the third wall portion at least in some part(s) forming a first supply line that can be flown through by a heat exchange medium,
wherein the heat exchanger chamber is hydraulically connected to the first supply line via a first connection region,
a fourth wall portion connecting the first wall portion and the second wall portion, the fourth wall portion at least in some part(s) forming a second supply line that can be flown through by a heat exchange medium,
wherein the heat exchanger chamber is hydraulically connected to the second supply line via a second connection region.

Advantageously, the heat exchanger device according to the invention can be manufactured in a simple manner, since the first and second supply lines are formed by means of the heat exchanger wall, i.e. the third and fourth wall portions of the heat exchanger wall. Thus, additional assembly work to connect the supply lines to the other elements of the heat exchanger device can be reduced. Further advantageously, the heat exchanger device according to the invention can be formed in a material-saving manner, especially compact, and with a smooth surface, so that the risk of injury during the assembly work in the sewage pipeline is reduced and the heat exchanger device is particularly easy to clean.

The heat exchanger device according to the invention is designed to be introducible into a sewage pipeline along a longitudinal direction L, wherein the sewage pipeline extends substantially along the longitudinal direction L, and wherein the sewage in the sewage pipeline flows substantially along the longitudinal direction L. In case that the sewage pipeline has a cylindrical cross-section, the longitudinal direction L is parallel to the cylinder axis. The first and second supply lines also extend substantially along the longitudinal direction L.

Moreover, the heat exchanger device according to the invention is designed such that the sewage is in contact, i.e. at least in thermal contact, with the first wall portion of the heat exchanger wall, which is preferably made of a heat-conducting, rigid material, in particular corrosion-resistant stainless steel. The thermal contact designates the transition of thermal energy from the sewage into the heat exchanger wall and vice versa. In addition to a thermal contact, the contact can in particular comprise direct wetting of the heat exchanger wall by sewage.

The in particular rigid second wall portion is arranged on the side of the heat exchanger device opposite to the sewage side. The second wall portion is directly and/or indirectly connected to the first wall portion by means of the third and fourth wall portions. The first and second wall portions are arranged in a manner spaced from each other, so that the heat exchanger chamber is formed between them. Preferably, the clear distance between the first and second wall portions is between approximately 1 mm and approximately 10 mm, preferably between approximately 2 mm and approximately 7 mm, in particular approximately 5 mm.

The heat exchanger chamber can be charged with the heat exchange medium (a fluid, e.g. water) via the first connection region and the first supply line, and can be drained via the second connection region and the second supply line. That is, the heat exchanger chamber is hydraulically connectable to the outside by means of the first and second supply lines, and apart from that is substantially fluid-tight or water-tight against the outside, in particular against the sewage.

For the purposes of the invention, the term “substantially” can describe a deviation from a target direction, in particular a deviation within the scope of the manufacturing accuracy and/or within the scope of the necessary accuracy, so that an effect as is present with the target direction is maintained. Therefore, when directions are indicated, the term “substantially” can include a deviation of less than approximately 20 degrees, less than approximately 10 degrees, less than approximately 5 degrees, preferably less than approximately 1 degree from a target direction. The term “substantially” comprises the term “identical”, i.e. “without a deviation from a target direction”.

Here, it is appreciated that the cross-sectional form of the heat exchanger device is designed such that it is adapted to the respective cross-section of the sewage pipeline concerned. To introduce the heat exchanger device into the sewage pipeline without having to expose the free ends of the sewage pipeline via foundation ditches, the dimensions of the individual heat exchanger devices are such that the heat exchanger devices can be brought to the end position through a conduit manhole in the sewage pipeline and then along or opposite to the longitudinal direction L of the sewage pipeline.

Preferably, the third wall portion and the fourth wall portion are arranged at opposite end regions of the heat exchanger device. In other words, the third wall portion is arranged in a manner spaced from the fourth wall portion along a width direction B, which is substantially perpendicular to the longitudinal direction L. Advantageously, the heat exchanger wall is then formed mirror-symmetrically, the width direction B being perpendicular to the mirror plane.

Preferably, the third wall portion and/or the fourth wall portion are substantially formed as an open cylinder surface. It is appreciated that the circular cross-section of the cylinder surface can also be approximated by a polygonal cross-section.

Preferably, the first connection region has a first connection opening, and the second connection region has a second connection opening. Here, the first and/or second connection opening(s) can have a circular, oval, rectangular, slot-like, or another form.

Preferably, the first connection opening is arranged in a manner spaced from the second connection opening in the longitudinal direction L. Advantageously, the flow path is made longer by this arrangement, so that the heat exchange medium flowing through the heat exchanger chamber remains in the heat exchanger chamber for a longer time, whereby thermal contact with the sewage is prolonged.

Preferably, the first connection region has a plurality of first connection openings, and the second connection region has a plurality of second connection openings. Preferably, each of the first connection openings is assigned a—in particular exactly one—second connection opening.

Preferably, the number of the first connection openings is equal to the number of the second connection openings.

Preferably, each of the first connection openings is arranged in a manner spaced from an assigned second connection opening along the longitudinal direction L. Thereby, a heat exchange medium can flow through the heat exchanger chamber along the longitudinal direction L over a longest possible path, whereby the time in which the heat exchanger medium is in thermal contact with the sewage is advantageously prolonged.

Preferably, the first wall portion and/or the second wall portion are formed substantially as an open cylinder surface.

Preferably, at least one spacer means is arranged between the first wall portion and the second wall portion.

Preferably, the at least one spacer means is arranged such that a fluid, which flows from the first connection opening to the second assigned connection opening, meanders transversely to the longitudinal direction L.

In other words, preferably one or more webs can be arranged in a manner spaced from each other in the heat exchanger chamber between the first wall portion and the second wall portion to further prolong the flow path and at the same time stabilize the heat exchanger chamber. Here, on the one hand, the webs function as a spacer means to ensure the predetermined clear distance between the first wall portion and the second wall portion in the heat exchanger chamber and to increase the torsional stiffness, so that advantageously the material of the heat exchanger wall can exhibit a lower material strength. On the other hand, the webs function as a chicane, so that the heat exchanger medium flowing over the flow path from the first connection opening to the second assigned connection opening path meanders along the width direction B, i.e. transversely to the longitudinal direction L.

Preferably, the first wall portion, the second wall portion, the third wall portion, and the fourth wall portion together are formed integrally. In particular, the four wall portions are formed of a metal sheet, for example of a stainless steel sheet. Expediently, the heat exchanger wall can be formed by rolling or bending the metal sheet about the longitudinal direction L, for example by means of a CNC rolling machine. Advantageously, the heat exchanger chamber and the supply lines can be formed in one process step, wherein the individual elements are already connected to each other in the right relative position.

Preferably, the heat exchanger device comprises at least one protective element, wherein the protective element is fixed to the heat exchanger wall with one end region, and the end region opposite thereto is designed to contact the sewage pipeline.

The protective element is preferably formed as a plate that is impermeable to water, so that solids entrained in the sewage advantageously do not collect between the heat exchanger wall and the inner wall of the sewage pipeline, or not on the third supply line. Further preferably, the protective element can be formed as a screening plate or grid, so that particles having a predetermined maximum particle diameter cannot pass the screening plate or grid. Advantageously, there is more space for the sewage within the sewage pipeline, wherein solids entrained in the sewage cannot collect. Particularly preferably, the protective element is made of a corrosion-resistant material, for example stainless steel or plastics, and in particular is fixed to the heat exchanger wall with two opposite ends thereof, for example by welding.

Preferably, the heat exchanger device comprises a third supply line. The third supply line is necessary to establish circulation of the heat exchange medium according to the Tichelmann principle. The third supply line is preferably fixed to the heat exchanger wall, for example by welding, screwing, or the like.

Preferably, the third supply line is arranged on the third wall portion or on the fourth wall portion.

Preferably, the third supply line is arranged between the protective element and the heat exchanger wall. Here, the protective element can be formed as a plate that is impermeable to water, whereby the protective element advantageously prevents corrosive chemical entrained in the sewage from attacking the third supply line.

Advantageously, the heat exchanger device has in its end regions connecting configurations for the pressure-tight and tension-resistant connection of one or more further heat exchanger devices. The end regions of the heat exchanger device, in particular of the heat exchanger wall, can preferably have clamp, plug and/or bolted, or screwed, connections to achieve a fixed connection between two similar heat exchanger devices.

Preferably, the first and second supply lines of the heat exchanger device are connected to first and second supply lines of the further heat exchanger device, respectively. Here, the first and second supply lines of the interconnected heat exchanger devices form a segment of a forward-run line, or advance piping, and return-run line, or return piping. Here, the pressure tightness is designed such that the pressure prevailing in the forward and return-run lines cannot loosen the connection between individual heat exchanger devices. Tension resistance between the heat exchanger devices is therefore advantageously to be provided in order to ensure that, in the event of repair or of exchange, there is the possibility of being able to draw individual interconnected heat exchanger devices in the sewage pipeline, for example in the direction of a conduit manhole, without these coming loose from one another.

Preferably, a socket and/or a pipe coupling are formed at the end regions of the first supply line and/or of the second supply line and/or of the third supply line.

Advantageously, by means of the socket or by means of the pipe coupling, a hydraulic connection between the corresponding supply lines can be established on the one hand, and a fixed mechanical connection can be formed on the other hand.

### Use

An aspect of the present invention relates to a use of at least one heat exchanger device according to the invention to form a heat exchanger assembly,
wherein the heat exchanger device is subsequently introduced into an existing sewage pipeline,
wherein the first supply line is connected to a forward-run line,
wherein the second supply line is connected to a return-run line, and
wherein the forward-run line and the return-run line are hydraulically connected to a heat pump.

Preferably, the longitudinal or widthwise extension of the rigid heat exchanger device can be selected such that it can be introduced through an above-ground conduit manhole of the respective sewage pipeline. According to the common clear width of conduit manholes, in this case, preferably a longitudinal or widthwise extension of approximately 80 cm, particularly preferably of 62.5 cm should not be overshot. Advantageously, there is thus a possibility of introducing the individual heat exchanger devices into sewage pipelines subsequently without having to provide access to the sewage pipelines via foundation ditches, since the individual heat exchanger devices can be introduced into the sewage pipeline through the numerous conduit manholes present. It is therefore easily possible to introduce one or more heat exchanger devices through the conduit manhole, in order thereafter to lay them in the sewage pipeline. Preferably, to achieve a required efficiency, a plurality of individual heat exchanger devices are introduced into the sewage pipeline and connected to each other.

Since the outer diameter of the heat exchanger device preferably corresponds to the inner diameter of the sewage pipeline, the heat exchanger device rests directly and substantially without a gap on the inner wall of the sewage pipeline. In order to arrange the heat exchanger device in the sewage pipeline in a secure position, further preferably an adhesive is arranged at least in some part(s) between the heat exchanger device and the inner wall of the sewage pipeline. Alternatively, one or more or all heat exchanger devices can be fixed to the inner wall of the sewage pipeline by fastening means, for example screws, anchors, clamp connections, etc.

The use of the proposed heat exchanger devices is appropriate particularly in town center areas where digging-up to reach the sewage pipeline is usually not possible. However, precisely in town center areas, there are sufficient conduit manholes which make it possible to introduce the heat exchanger devices into the sewage pipeline.

Here, it is appreciated that, in a known way, the first and second supply lines of the individual heat exchanger devices are connected to the forward-run and return-run lines, so that the cold heat exchange medium can flow from the heat pump via the forward-run line through the aforementioned heat exchanger devices and finally, in a heated state, via the return-run line back to the heat pump. For the configuration of the heat exchanger chambers and the designs of the lines for forward-run, return-run and distribution of the heat exchanger medium (third supply line), the Tichelmann system can advantageously be employed in order to optimize the efficiency of the heat exchanger devices.

The preceding description of the aspects of the invention is not limited to the respective aspects. Instead, the explanations of the respective aspects apply analogously to the further aspects of the invention. In particular, the explanations concerning the heat exchanger device also apply to the use and the heat exchanger assembly and preferred embodiments or variants thereof.

### DESCRIPTION OF FIGURES

Preferred embodiments of the present invention will be described by way of example in the following on the basis of accompanying drawings. Individual elements of the described embodiments are not limited to the respective embodiment. Instead, elements of the embodiments can be combined in an arbitrary manner, and new embodiments can be provided thereby. The figures show:

FIG. 1: a cross-section through a preferred embodiment of a heat exchanger device,

FIG. 2: a detailed view of the cross-section shown in FIG. 1,

FIG. 3: a connecting configuration connecting two heat exchanger devices,

FIG. 4: a schematic block diagram of a heat exchanger assembly.

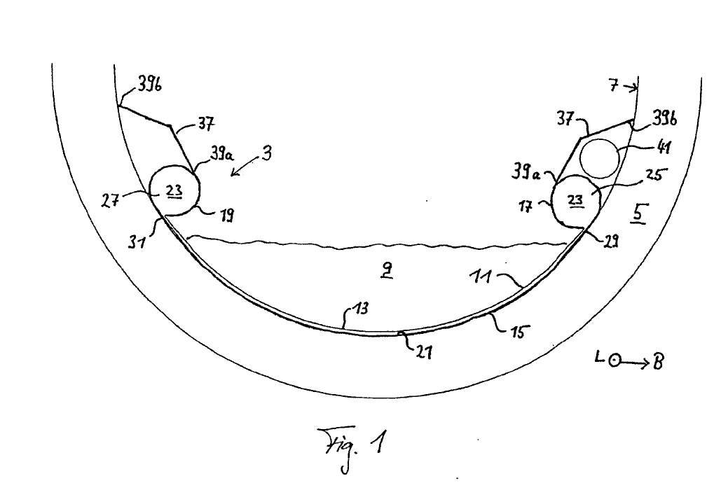

FIG. 1 shows a cross-section through a heat exchanger device 3 in a sewage pipeline 5. The heat exchanger device 3 comprises a heat exchanger wall 11 having a first wall portion 13, a second wall portion 15, a third wall portion 17 and a fourth wall portion 19.

The second wall portion 15 faces the inner wall 7 of the sewage pipeline 5 and bears against the inner wall 13 in a flat manner at least in some part(s). Preferably, the second wall portion 15 has a predetermined radius of curvature R along the width direction B in order to bear against the inner wall 7 of the sewage pipeline 7 substantially without a gap. A remaining gap can be filled with an adhesive at least in some part(s). The adhesive may be thermally insulating in order to insulate the heat exchanger device 3 from the ground. Alternatively, the adhesive may be thermally insulating in order to additionally use the geothermal heat by means of the heat exchanger device 3. Preferably, the adhesive can serve as a support of the heat exchanger device 3. Further preferably, the heat exchanger device 3 can also bear directly against the inner wall 7 of the sewage pipeline 5.

The first wall portion 13 of the heat exchanger device 11 is designed to contact the sewage 9, i.e. to contact the sewage 9 thermally at least in some part(s) or to be wetted by the sewage 9. The first wall portion 13 is arranged in a manner spaced from the second wall portion 15, whereby a heat exchanger chamber 21 is formed between the first wall portion 13 and the second wall portion 15.

At least the first wall portion 13 of the heat exchanger wall 11 is made of a rigid, heat-conducting material, so that an exchange of thermal energy takes place between the sewage 9 and a heat exchange medium 23 in the heat exchanger chamber 21 via the first wall portion 13.

In order to transfer the thermal energy of the sewage 9 into the heat exchange medium 23 and to utilize it, there has to be a thermal gradient between the sewage 9 and the heat exchange medium 23. In other words, there must not be a thermal balance between those two, but the heat exchange medium 23 has to exhibit a lower temperature than the sewage 9. For this reason, during operation of the heat exchanger device 3, cool heat exchange medium 23 is fed continuously into the heat exchanger chamber 21 from a first supply line 25, also referred to as a forward-run 25, via a first connection region 29. In the heat exchanger chamber 21, the heat exchange medium 23 heats up depending on the temperature of the sewage 9 in order to be fed into a second supply line 27, which can also be referred as a return-run 27, via a second connection region 31 in the heated state. The thermal energy can be transported to a consumer of the thermal energy stored in the heat exchange medium 23 via the return-run 27.

In the embodiment shown in FIG. 1, the first supply line 25 is formed by a third wall portion 17 of the heat exchanger wall 11 in some part(s), i.e. except for the first connection region 29, wherein the third wall portion 17 connects the first wall portion 13 and the second wall portion 15 to each other The third wall portion 17 is formed substantially cylindrically or tubularly, except for the transition region to the first connection region 29, where the third wall portion 17 has to deviate from the cylinder shape or tube shape in order to have a continuous connection to the first wall portion 13 and the second wall portion 15.

By analogy with the first supply line 25, the second supply line 27 is formed at the end of the heat exchanger device 3 which is opposite in the width direction B. That is, the second supply line 27, except for the second connection region 31, is formed by a fourth wall portion 19 of the heat exchanger wall 11. Here, the fourth wall portion 19 also connects the first wall portion 13 and the second wall portion 15 with each other, so that the four wall portions 13, 15, 17, 19 form a circumferential, closed heat exchanger wall 11 about the longitudinal direction L. By analogy with the third wall portion 17, the fourth wall portion 19 is also formed cylindrically or tubularly, except for the transition region to the second connection region 31.

Preferably, the heat exchanger wall 11 is formed integrally with the four wall portions 13, 15, 17, 19, in particular from a metal sheet, for example from a stainless steel sheet. The heat exchanger wall 11 can be formed by rolling of the metal sheet or by bending along the longitudinal direction L. Advantageously, the required radii of curvature in the individual portions of the heat exchanger wall 11 can be formed dimensionally stable by rolling of the metal sheet by means of a CNC rolling machine. Thereby, the heat exchanger chamber 21 and the supply lines 25, 27 can be formed in one process step, wherein the individual elements are already in the right relative position with respect to each other.

In order to connect the first supply line 25 hydraulically to the heat exchanger chamber 21, the first connection region 29 has at least one first connection opening 33. Analogously, the second connection region 31 comprises at least one second connection opening 35 to hydraulically connect the heat exchanger chamber 21 to the second supply line 27.

Depending on the desired flow velocity and the expected temperature gradient, the number of the first connection openings 33, the number of the second connection openings 35, and their geometric arrangement with respect to each other can be selected.

In a preferred embodiment, the first connection region 29 only comprises one first connection opening 33, and the second connection region 31 only comprises one second connection opening 35. In this case, the first connection opening 33 and the second connection opening 35 are preferably arranged in a manner spaced from each other in the longitudinal direction L. The flow path is prolonged by this arrangement, so that the heat exchanger medium 23 is in indirect thermal contact with the sewage 9 for a longer period of time. In the heat exchanger chamber 21, one or more webs (not illustrated) can be arranged in a manner spaced from each other between the first wall 13 and the second wall portion 15, or be connected thereto, in order to further prolong the flow path. The connection can preferably be established by welding. Here, on the one hand, the webs function as a spacer means to fix the clear distance between the first wall portion 13 and the second wall portion 15 in the heat exchanger chamber 21, and, on the other hand, as a chicane, so that the heat exchanger medium 23, which flows from the first connection opening 33 to the second assigned connection opening 35 substantially along the longitudinal direction L, meanders along the width direction B, i.e. transversely to the longitudinal direction L.

In a further preferred embodiment, the first connection region 29 can have a plurality of first connection openings 33, and the second connection region 31 can have a plurality of second connection openings 35. Preferably, each of the first connection openings 33 is assigned a second connection opening 35. Particularly preferably, the number of the first connection openings 33 corresponds precisely to the number of the second connection openings 35. Further preferably, each of the first connection openings 33 is arranged in a manner spaced from the assigned second connection opening 35 along the longitudinal direction L. As described above, the flow path between two connection openings 33, 35 can be prolonged in that one or more webs or spacer means (not illustrated) are arranged in a manner spaced from each other between the first wall portion 13 and the second wall portion 15, or are connected thereto, so that the heat exchanger medium 23, which flows from the first connection opening 33 to the second assigned connection opening 35, meanders along the width direction B.

Moreover, the embodiment of the heat exchanger device 3 shown in FIG. 1 has two protective elements 37. The protective elements 37 are fixed to the heat exchanger wall 11 with an end region 39a thereof, for example by a weld seam continuous along the longitudinal direction L. In particular, fixing can be performed at the third or fourth wall portions 17, 19. The free end region 39b of the protective elements opposite to the fixed end region bears against the inner wall 7 of the sewage pipeline 5 and can preferably be fixed thereto. Preferably, the protective elements 37 form run-off surfaces, so that advantageously no solid particles entrained in the sewage can collect in the narrowed region between the heat exchanger wall 11 and the inner wall 7 of the sewage pipeline 5. Preferably, between the protective element 37, the heat exchanger wall 11, and the inner wall 7 is formed a free space in which a third supply line 41 can be arranged. The third supply line 41 is necessary to establish circulation of the heat exchange medium 23 according to the Tichelmann principle, wherein the third supply line is preferably fixed to the heat exchanger wall 11, for example by welding, screwing, or the like.

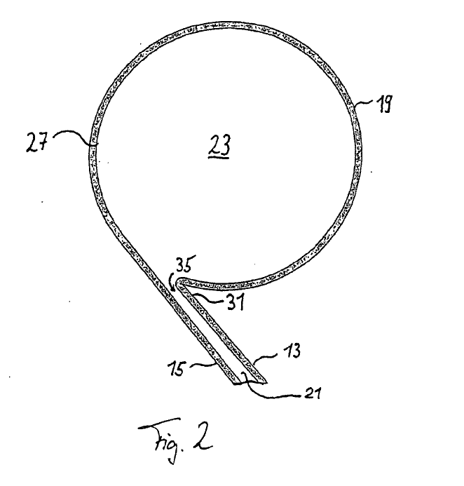

FIG. 2 shows a detailed view of the heat exchanger device 3 shown in FIG. 1, comprising the first wall portion 13, the second wall portion 15, and the fourth wall portion 19. Here, the distance between the first wall portion 13 and the second wall portion 15 is substantially constant, wherein the first wall portion 13 and the second wall portion are substantially formed as cylinder sub-surfaces, the cylinder axes of which substantially coincide. In other words, the radius of curvature of the first wall portion 13 is smaller than the radius of curvature of the second wall portion 15, wherein the centers of the circles of curvature coincide. Advantageously, these simple geometric forms of the individual wall portions can be produced in a particularly simple manner. Only the connection regions 29, 31 require an increased manufacturing effort for their production. Besides, the features in FIG. 2 identical with those in FIG. 1 are designated with identical reference numerals.

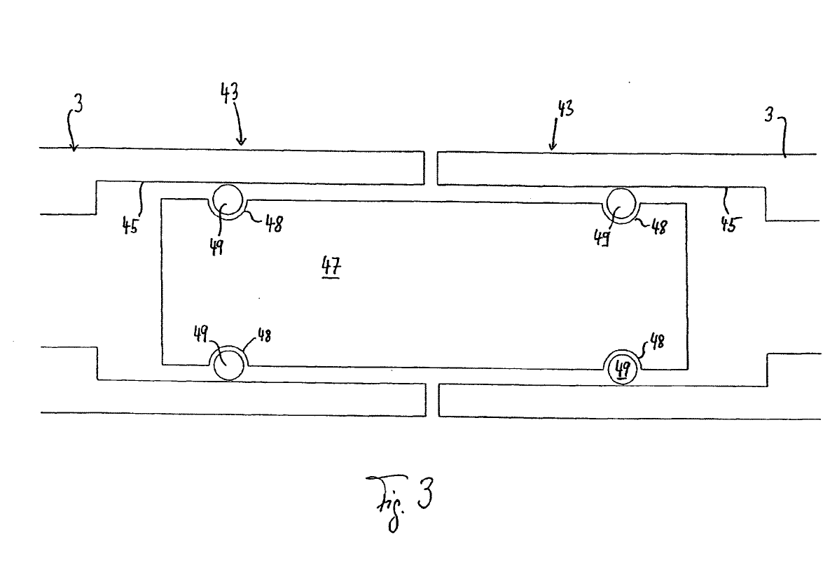

FIG. 3 shows a connecting configuration 43 for the pressure-tight and tension-resistant connection of one or more further heat exchanger devices to the heat exchanger device 3, in order to be able to connect several heat exchanger devices to each other to form a heat exchanger assembly. In particular, the first supply line 25 comprises a socket 45, so that the first supply line 25 of the heat exchanger device 3 can be connected to a socket 45 of a supply line of a further heat exchanger device 3 in a pressure and fluid-tight manner. It goes without saying that as an alternative to a socket connector 47, the socket 45 of the heat exchanger device 3 can be connected to a complementary socket (not illustrated) of the further heat exchanger device 3 in a pressure and fluid-tight manner. In order to establish a reliable pressure-tight connection, the socket 45 and/or the socket connector 47 and/or the complementary socket can have a circumferential recess or groove 48 into which a sealing ring 49 can be inserted. Analogously, the second supply line 27 and the third supply line 41 can also have a socket.

In case that the third wall portion 17 and/or the fourth wall portion 19 deviate from the cylinder shape or from the tube shape such that a pressure-tight connection is not ensured, a socket body can be arranged at the end region of the first supply line 25 formed by the third wall portion 17 and/or at the end region of the second supply line 27 formed by the fourth wall portion 19, in particular be fixed by welding or shrinking. Alternatively, a socket 45 can also be formed by machining, or cutting, of the end region of the first or second supply line 25, 27.

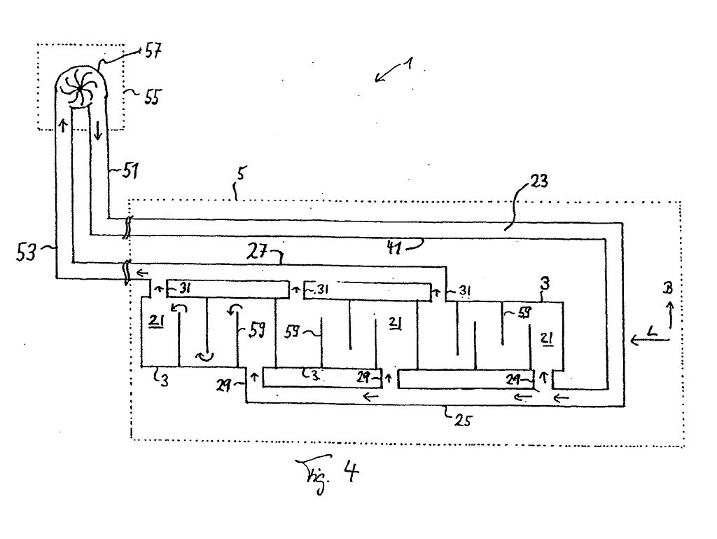

FIG. 4 shows a schematic block diagram of a heat exchanger assembly 1 with a heat exchanger device 3 in a sewage pipeline 5. A forward-run line 51, a return-run line 53, and a third supply line or distributor line 41 are illustrated. The forward-run line 51 is connected to the first supply lines 25 via the third supply line 41 and the return-run line 53 is connected to the second supply lines 27 of the heat exchanger devices 3. Preferably, the forward-run line 51 and the return-run line 53 are lead out from the sewage pipeline through a conduit manhole (not illustrated) in order to be connected to a heat exchanger system 55, which is usually arranged above ground, with a heat pump 57.

A heat exchange medium 23 is led through the corresponding lines according to the Tichelmann principle. Here, the cold heat exchange medium 23 is led from the heat pump 57 via the third supply line 41 to the point of the line system most remote from the heat pump 57, and from there is distributed to the first supply lines 25 of the individual heat exchanger devices 3 by means of the forward-run line 51. The cold heat exchange medium 23 then flows through the heat exchanger chambers 21 of the individual heat exchanger devices 3 and finally, in the heated state, via the second supply lines 27 and the return-run line 53 back to the heat pump 57.

As is illustrated in FIG. 4, the heat exchange medium 23 flows meanderingly through the heat exchanger chambers 21, which prolong the flow path of the heat exchange medium 23 by means of rectilinear spacer means or webs or chicanes 59.

### LIST OF REFERENCE NUMERALS

1 heat exchanger assembly

3 heat exchanger device

5 sewage pipeline

7 inner wall of the sewage pipeline 5

9 sewage

11 heat exchanger wall

13 first wall portion

15 second wall portion

17 third wall portion

19 fourth wall portion

21 heat exchanger chamber

23 heat exchange medium

25 first supply line

27 second supply line

29 first connection region

31 second connection region

33 first connection opening

35 second connection opening

37 protective element

39a,b end regions of the protective element 37

41 third supply line or distributor line

43 connecting configuration

45 socket

47 socket connector

48 groove

49 sealing ring

51 forward-run line

53 return-run line

55 heat exchanger system

57 heat pump

59 web or chicane or spacer means

B width direction

L longitudinal direction

1. A heat exchanger device to be introduced into a sewage pipeline having a longitudinal direction L, the heat exchanger device comprising:
a first wall portion configured to make contact with sewage;
a second wall portion spaced from the first wall portion, the second wall portion configured to make contact with the sewage pipeline, wherein the first wall portion and the second wall portion are arranged in a manner spaced apart from each other such that a heat exchanger chamber is formed between the first wall portion and the second wall portion;
a third wall portion coupled between the first wall portion and the second wall portion, the third wall portion comprising at least a portion of a first supply line, wherein the heat exchanger chamber is hydraulically connected to the first supply line via a first connection region;
a fourth wall portion coupled between the first wall portion and the second wall portion, the fourth wall portion comprising at least a portion of a second supply line,
wherein the heat exchanger chamber is hydraulically connected to the second supply line via a second connection region.

2. The heat exchanger device according to claim 1, wherein the third wall portion and the fourth wall portion are arranged at opposite end regions of the heat exchanger device.

3. The heat exchanger device according to claim 1, wherein the third wall portion and/or the fourth wall portion are substantially formed as an open cylinder surface.

4. The heat exchanger device according to claim 1, wherein the first connection region has a first connection opening, and the second connection region has a second connection opening.

5. The heat exchanger device according to claim 4, wherein the first connection opening is arranged in a manner spaced apart from the second connection opening in the longitudinal direction L.

6. The heat exchanger device according to claim 1, wherein the first connection region comprises a plurality of first connection openings, and the second connection region comprises a plurality of second connection openings.

7. The heat exchanger device according to claim 6, wherein the number of the first connection openings is equal to the number of the second connection openings.

8. The heat exchanger device according to claim 7, wherein each of the first connection openings is arranged in a manner spaced from an assigned second connection opening along the longitudinal direction L.

9. The heat exchanger device according to claim 1, wherein the first wall portion and/or the second wall portion are formed substantially as an open cylinder surface.

10. The heat exchanger device according to claim 1, further comprising at least one spacer means arranged between the first wall portion and the second wall portion.

11. The heat exchanger device according to claim 10, wherein the at least one spacer means is arranged such that a fluid flowing from the first connection opening to the second assigned connection opening meanders transversely to the longitudinal direction L.

12. The heat exchanger device according to claim 1, wherein the first wall portion, the second wall portion, the third wall portion, and the fourth wall portion together are formed integrally.

13. The heat exchanger device according to claim 1, further comprising at least one protective element comprising a first end region and a second end region opposite thereto, wherein the first end region is fixed to the heat exchanger wall and the second end region is configured to contact the sewage pipeline.

14. The heat exchanger device according to claim 13, further comprising a third supply line.

15. The heat exchanger device according to claim 14, wherein the third supply line is arranged on one of the third wall portion or on and the fourth wall portion.

16. The heat exchanger device according to claim 14, wherein the third supply line is arranged between the protective element and the heat exchanger wall.

17. The heat exchanger device according to claim 14, wherein the first and second end regions are configured to allow pressure-tight and tension-resistant connection of one or more further heat exchanger devices.

18. The heat exchanger device according to claim 2, wherein:
one or more of the first supply line, the second supply line, and the third supply line comprise a respective end region; and
at least one of the first supply line end region, the second supply line end region, and the third supply line end region comprises a socket.

19. A method of extracting energy from sewage, the method comprising the steps of:
introducing a heat exchanger device comprising a first wall portion configured to make contact with sewage, a second wall portion configured to make contact with a wall of a sewage pipeline, wherein the first wall portion and the second wall portion are configured to form a heat exchanger chamber, the heat exchanger device further comprising first and second supply lines each hydraulically coupled to the heat exchanger chamber, into an existing sewage pipeline,
coupling a forward-run line to the first supply line;
coupling a return-run line to wherein the second supply line; and
providing a heat exchange medium into the forward-run line and accepting the heat exchange medium from the return-run line.
